(19) United States
(12) Patent Application Publication
(10) Pub. No.: US 2007/0174833 A1
(43) Pub. Date: Jul. 26, 2007

(54) Plug and install system and method

(75) Inventor: Jae-seong Im, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/637,100

(22) Filed: Dec. 12, 2006

(30) Foreign Application Priority Data
Jan. 20, 2006 (KR) 2006-6466

(51) Int. Cl. G06F 9/445

(52) U.S. Cl. 717/174

(57) ABSTRACT

A plug and install system including a hardware-to-application mapping table having hardware and a list of application programs associated the hardware recorded therein; a storage module storing installation files to install the application programs; a hardware detecting module detecting newly installed hardware; and a control module selecting an application program associated with the hardware detected by the hardware detecting module from the hardware-to-application mapping table, extracting an installation file to install the selected application program from the storage module, and installing the application program.

### CROSS-REFERENCE TO RELATED APPLICATION

This application claims the benefit of Korean Patent Application No. 2006-6466 filed on Jan. 20, 2006 in the Korean Intellectual Property Office, the disclosure of which is incorporated herein by reference.

### BACKGROUND OF THE INVENTION

1. Field of the Invention

Aspects of the present invention relate to plug and install, and more specifically, to a system and method to detect newly installed hardware and to automatically install an application program associated with the detected hardware.

2. Description of the Related Art

Typically, many hardware items can be installed in a computer system. Therefore, when new hardware is installed, a device driver to drive the hardware and application programs using the hardware must usually be installed. Such installation is complicated and often inconvenient for an end user.

In order to reduce the inconvenience, Korean Patent Publication No. 2003-43127 discloses a method of installing a hardware driver into a computer by one click, which includes a step of booting a computer after hardware is installed in the computer, a step in which a user selects “cancel” when the computer finds a new device and asks whether to install a driver, a step in which the user executes a driver installation program for the hardware after the computer operating system is booted, a step of preparing a driver installation environment formed of components of the operating system required to install the driver, and a step in which the driver installation program installs the driver by using installation functions of the operating system under the driver installation environment. The invention disclosed in Korean Patent Publication No. 2003-43127 has an advantage in that a procedure of installing a driver after a user installs hardware in a computer is automatically performed without a response of the user.

However, since such a plug and play function is focused on a device driver, it is difficult to apply the plug and play function to an application program.

This is because a device driver is software for exclusive use of specific hardware while application programs are software not for exclusive use of specific hardware.

Further, when a predetermined application program is not retrieved at the time when a specific file is opened, a Windows system automatically searches for the predetermined application program through the Internet and automatically installs the predetermined application program. However, the Windows system does not automatically install application programs associated with newly connected hardware.

Therefore, a method of automatically installing an application program associated with new hardware as well as a device driver to drive the new hardware when the new hardware is connected to a system is needed.

### SUMMARY OF THE INVENTION

Aspects of the present invention provide a method of automatically detecting new hardware and automatically installing an application program associated with the new hardware when the new hardware is installed in a system.

According to an aspect of the present invention, there is provided a plug and install system including: a hardware-to-application mapping table having hardware and a list of application programs associated the hardware recorded therein; a storage module storing installation files to install the application programs; a hardware detecting module detecting newly installed hardware; and a control module selecting an application program associated with the hardware detected by the hardware detecting module from the hardware-to-application mapping table, extracting an installation file to install the selected application program from the storage module, and installing the application program.

According to another aspect of the present invention, there is provided a plug and install system including: a hardware-to-application mapping table having hardware, a list of application programs associated the hardware, and information on a remote network apparatus having installation files to install the application programs recorded therein; a network interface module connected to the remote network apparatus to receive the installation files; a hardware detecting module detecting newly installed hardware; and a control module selecting an application program associated with the hardware detected by the hardware detecting module from the hardware-to-application mapping table, receiving the corresponding installation file through the network interface module on the basis of the information on the remote network apparatus, and installing the corresponding application program.

According to still another aspect of the present invention, there is provided a plug and install method including: detecting newly installed hardware; retrieving an installation file to install an application file associated with the detected hardware; and executing the retrieved installation file to install the corresponding application program.

According to yet another aspect of the present invention, there is provided a plug and install method including: detecting newly installed hardware; receiving, from a remote network apparatus, an installation file to install an application program associated with the detected hardware; and executing the received installation file to install the corresponding application program.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram showing a configuration of a plug and install system according to an embodiment of the present invention;

FIG. 2 is a view showing a hardware-to-application mapping table according to an embodiment of the present invention;

FIG. 3 is a view showing an example of a user interface according to an embodiment of the present invention;

FIG. 4 is a block diagram showing a configuration of a plug and install system according to another embodiment of the invention;

FIG. 5 is a view showing a hardware-to-application mapping table according to another embodiment of the invention; and

FIG. 6 is a flow chart illustrating a plug and install method according to an embodiment of the invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention are described hereinafter with reference to flowcharts and block diagrams illustrating a plug and install system and method according to embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create devices to implement the operations specified in the flowchart block or blocks. These computer program instructions may also be stored in a computer-usable or computer-readable memory that can direct a computer or other programmable data processing apparatus to function in a particular manner, such that the instructions stored in the computer-usable or computer-readable memory produce an article of manufacture including instruction devices that implement the operations specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide methods to implement the operations specified in the flowchart block or blocks.

Furthermore, each block of the flowchart illustrations may represent a module, segment, or portion of code, which comprises one or more executable instructions to implement the specified logical operation(s). It should also be noted that in some alternative implementations, the operations noted in the blocks may occur out of the order. For example, two blocks shown in succession may in fact be executed substantially concurrently or the blocks may sometimes be executed in the reverse order, depending upon the functionality involved.

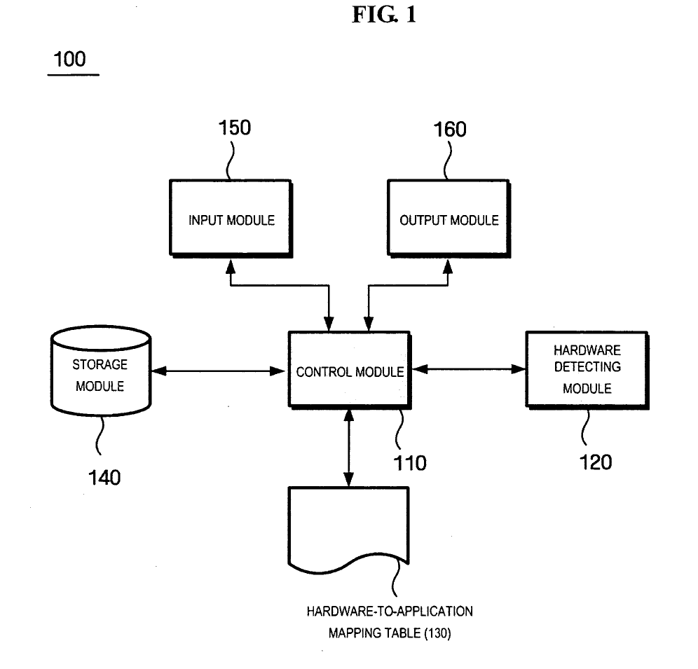

FIG. 1 is a block diagram showing a configuration of a plug and install system according to an embodiment of the present invention.

Referring to FIG. 1, a plug and install system 100 according to an embodiment of the present invention includes a control module 110, a hardware detecting module 120, a hardware-to-application mapping table 130, a storage module 140, an input module 150, and an output module 160.

When new hardware is installed in the plug and install system 100, the hardware detecting module 120 detects the new hardware and notifies the control module 110 of the detection of the new hardware.

The control module 110 controls an operation to install an application program associated with the detected new hardware. Hereinafter, the application program is an application program associated with the detected new hardware, unless otherwise specified.

The hardware-to-application mapping table 130 has a data structure in which a predetermined hardware is mapped to an application program list associated with the hardware. The hardware-to-application mapping table 130 is stored in a memory of the plug and install system 100. Alternatively, it may be recorded in a separate file and then stored in the storage module 140. Moreover, it is understood that the hardware-to-application mapping table 130 may be stored in an external storage device or an information storage medium that the plug and install system 100 can connect to through a wired or wireless connection.

The storage module 140 stores a device driver to drive the hardware and an installation file to install an application program recorded in the hardware-to-application mapping table 130. However, it is understood that the device driver may be stored in an external storage device or an information storage medium that the plug and install system 100 can connect to through a wired or wireless connection.

The input module 150 transmits the input of a user to the control module 110. The output module 160 displays a procedure of installing an application program to the user and can provide a user interface allowing the user to select a desired application program.

The term “module,” as used herein, refers to, but is not limited to, a software or hardware component, such as a Field Programmable Gate Array (FPGA) or Application Specific Integrated Circuit (ASIC), which performs certain tasks. A module may be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

Hereinafter, the operations of the individual modules constituting the plug and install system 100 will be described in detail.

First, when new hardware is installed in the plug and install system 100, the hardware detecting module 120 detects the new hardware and notifies the control module 110 of the detection of the new hardware. In this case, the hardware detecting module 120 can provide identification information of the detected new hardware to the control module 110.

The control module 110 extracts a device driver to drive the detected new hardware from the storage module 140 on the basis of the identification information on the detected new hardware received from the hardware detecting module 120, and executes the extracted device driver. If the device driver for the detected new hardware has already been installed, the above-mentioned operation can be omitted.

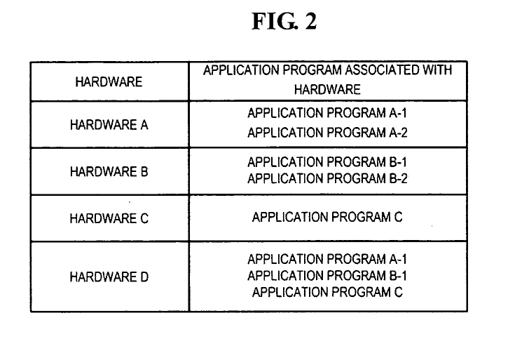

Further, the control module 110 checks an application program list associated with the detected new hardware from the hardware-to-application mapping table 130. FIG. 2 shows an example of the hardware-to-application mapping table 130.

Referring to FIG. 2, the hardware-to-application mapping table 130 includes a field representing a hardware list and a field representing a list of application programs associated with specific hardware. For example, when hardware D is newly installed in the plug and install system 100, application programs A-1, B-1, and C are associated with the hardware D.

When a list of application programs associated with the hardware detected by the hardware detecting module 120 exists in the hardware-to-application mapping table 130, the control module 110 extracts installation files to install the corresponding application programs from the storage module 140 and automatically executes the installation files, thereby installing the corresponding application programs in the plug and install system 100. After the application programs are installed in the plug and install system 100, the corresponding installation files may be deleted. However, it is understood that the installation files may be stored in an external storage device or an information storage medium that the plug and install system 100 can connect to through a wired or wireless connection.

When new hardware is detected, the output module 160 can display to a user a procedure of installing the corresponding device driver and a procedure of installing an application program associated with the detected hardware. The user can see which application is being currently installed through the output module 160. Furthermore, according to an aspect of the present invention, the user may choose whether to install the application program through the input module 150. Information on whether the user chooses to install the application program is transmitted to the control module 110 from the input module 150.

When a plurality of application programs are associated with the detected hardware, the control module 110 can provide, through the output module 160, a user interface allowing the user to select a desired one of the corresponding application programs.

In this case, when the user selects a specific application program, information on the selected application program is transmitted to the control module 110 through the input module 150. Then, the control module 110 extracts an installation file to install the application program selected by the user from the storage module 140 and installs the corresponding application program in the plug and install system 100.

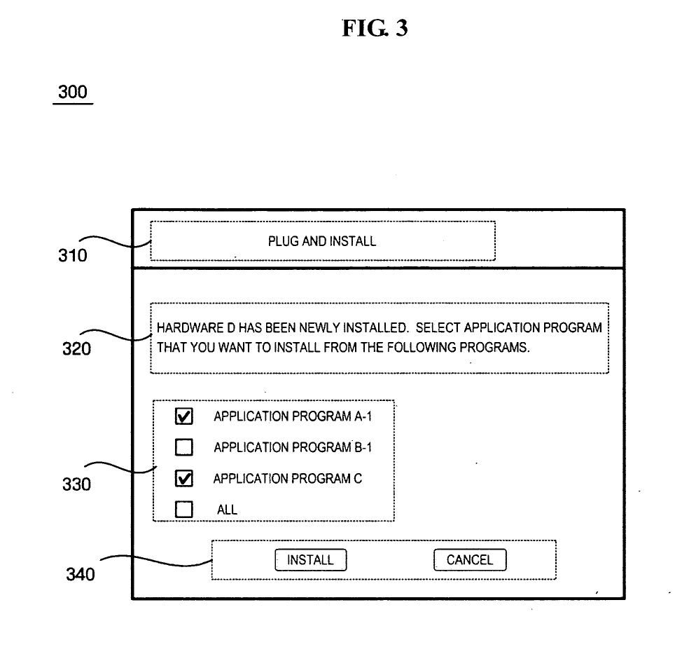

FIG. 3 shows an example of the user interface 300 provided to the user through the output module 160.

Referring to FIG. 3, a user interface 300 includes: a first region 310, representing that the user interface is an interface related to a plug and install function; a second region 320, informing the user which hardware has been newly installed; a third region 330, where a list of application programs associated with the newly installed hardware is displayed and a selection means through which the user selects desired application programs is provided; and a fourth region 340, including a command icon signifying a command to install the application programs selected by the user or a command icon signifying a command not to install the application programs associated with the corresponding hardware.

In FIG. 3, the second region 320 informs the user that the hardware D has been newly installed and the third region 330 represents that the user selected the application programs A-1 and C.

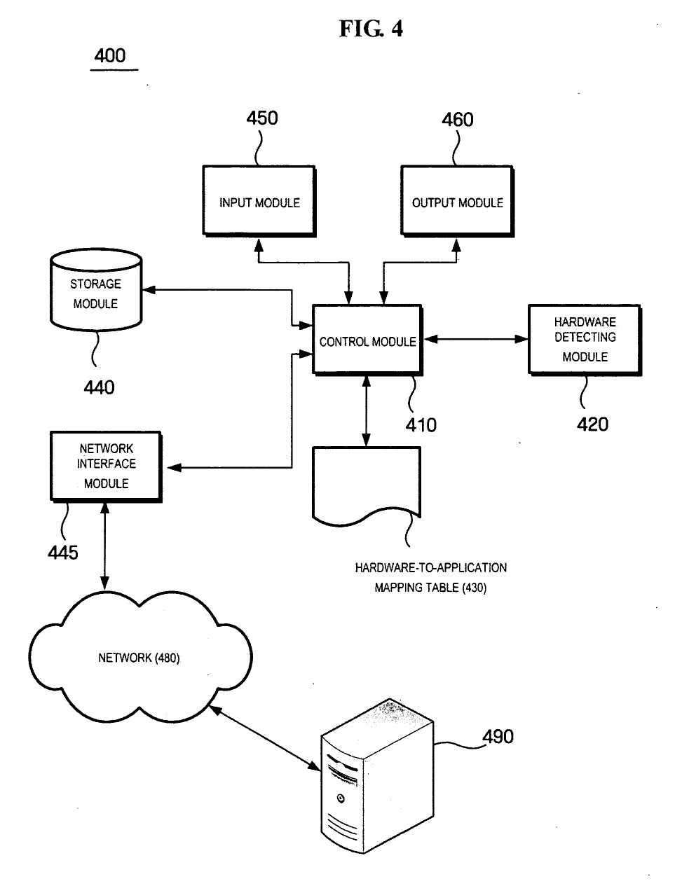

FIG. 4 is a block diagram showing a configuration of a plug and install system according to another embodiment of the present invention.

Referring to FIG. 4, a plug and install system 400 according to another embodiment of the present invention includes a control module 410, a hardware detecting module 420, a hardware-to-application mapping table 430, a storage module 440, an input module 450, an output module 460, and a network interface module 445.

When new hardware is installed in the plug and install system 400, the hardware detecting module 420 detects the new hardware and notifies the control module 410 of the detection of the new hardware.

The control module 410 controls an operation of installing an application program associated with the detected new hardware.

The hardware-to-application mapping table 430 has a data structure in which a predetermined hardware and an application program list associated with the hardware are mapped. The hardware-to-application mapping table 430 may be stored in a memory of the plug and install system 400, or it may be recorded in a separate file and then stored in the storage module 440. Moreover, it is understood that the hardware-to-application mapping table 430 may be stored in an external storage device or an information storage medium that the plug and install system 100 can connect to through a wired or wireless connection.

The storage module 440 stores a device driver to drive the hardware. However, it is understood that the device driver may be stored in an external storage device or an information storage medium that the plug and install system 100 can connect to through a wired or wireless connection.

The input module 450 transmits the input of a user to the control module 410. The output module 460 displays a procedure of installing an application program to the user and can provide a user interface allowing the user to select a desired application program.

The network interface module 445 receives installation files to install the application programs recorded in the hardware-to-application mapping table 430 from a remote network apparatus 490 through a network 480 and transmits the received installation files to the control module 410. The network 480 may be the Internet or an intranet, and the remote network apparatus 490 may be a data server. When a plurality of application programs are associated with the hardware detected by the hardware detecting module 420, a plurality of remote network apparatuses for providing installation files may be provided. However, it is understood that the installation files may be stored in the storage module 440.

First, when new hardware is installed in the plug and install system 400, the hardware detecting module 420 detects the new hardware and notifies the control module 410 of the detection of the new hardware. In this case, the hardware detecting module 420 can provide identification information on the detected new hardware to the control module 410.

The control module 410 extracts a device driver to drive the detected new hardware from the storage module 440 on the basis of the identification information on the detected new hardware received from the hardware detecting module 420, and executes the extracted device driver. If the device driver for the detected new hardware has already been installed, the above-mentioned operation can be omitted.

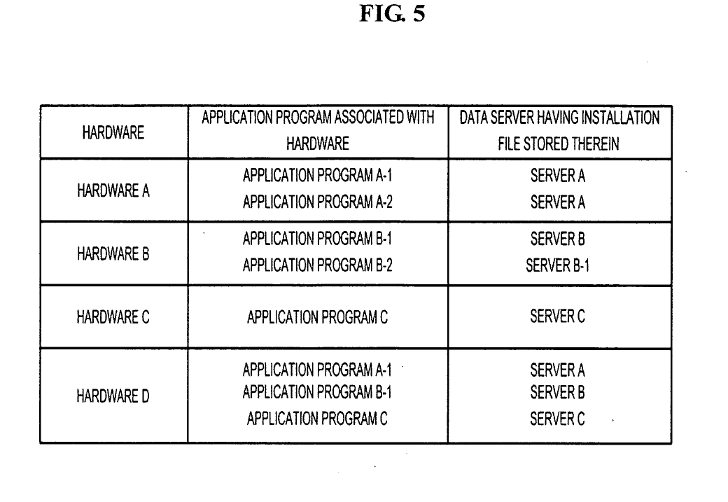

Further, the control module 410 checks a list of application programs associated with the detected new hardware from the hardware-to-application mapping table 430. FIG. 5 shows an example of the hardware-to-application mapping table 430.

Referring to FIG. 5, the hardware-to-application mapping table 430 includes a field representing a hardware list, a field representing a list of application programs associated with specific hardware, and a field representing a server in which installation files for the corresponding application programs are stored. For example, when hardware D is newly installed in the plug and install system 400, an application program A-1 stored in a server A, an application program B-1 stored in a server B, and an application program C stored in a server C are associated with the hardware D.

When a list of application programs associated with the hardware detected by the hardware detecting module 420 exists in the hardware-to-application mapping table 430, the control module 410 provides information on a remote network apparatus 490 having the installation file stored therein to the network interface module 445. The network interface module 445 connects, through a wired or wireless connection, to the remote network apparatus 490 having the installation file stored therein on the basis of the information received from the control module 410. It is understood that, according to an aspect of the present invention, the control module 410 may first search the storage module 440 for the required installation file, and if the installation file is not stored in the storage module 440, the control module may provide the information on the remote network apparatus 490 having the installation file to the network interface module 445.

Then, the network interface module 445 receives the corresponding installation file from the remote network apparatus 490 through the network 480 and transmits the received installation file to the control module 410.

The control module 410 automatically executes the received installation file, thereby installing the corresponding application program in the plug and install system 400.

After the application programs are installed in the plug and install system 100, the corresponding installation files may be deleted.

When new hardware is detected, the output module 460 can display to a user a procedure of installing the corresponding device driver and a procedure of installing an application program associated with the detected hardware. The user can see which application is being currently installed through the output module 460. Furthermore, according to an aspect of the present invention, the user may choose whether to install the application program through the input module 450. Information on whether the user chooses to install the application program is transmitted to the control module 410 from the input module 450.

When a plurality of application programs are associated with the detected hardware, the control module 410 can provide, through the output module 460, a user interface allowing the user to select a desired one of the corresponding application programs.

In this case, when the user selects a specific application program, information on the selected application program is transmitted to the control module 410 through the input module 450. The control module 410 receives an installation file to install the application program selected by the user from the remote network apparatus 490 through the network interface module 445 and installs the corresponding application program in the plug and install system 400.

For example, the user interface shown in FIG. 3 can be provided to the user through the output module 460.

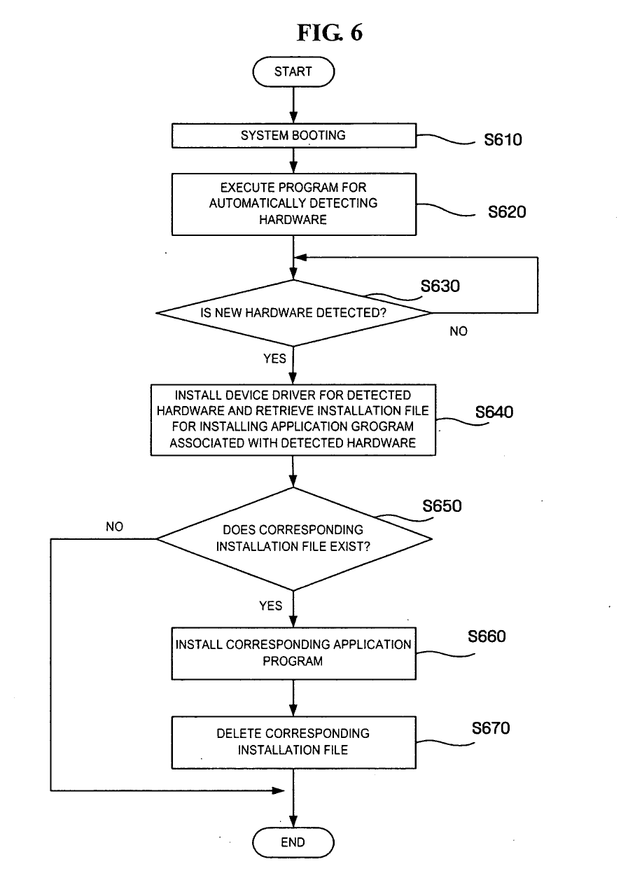

FIG. 6 is a flow chart illustrating a plug and install method according to an embodiment of the present invention.

First, a plug and install system 400 is booted (S610), and a program to automatically detect hardware of the plug and install system 400 is executed (S620).

The program checks whether new hardware has been installed in the plug and install system 400 (has been plugged into the plug and install system 400) (S630). When new hardware has been installed, a device driver for the detected hardware is installed, and an installation file to install an application program associated with the detected hardware is retrieved (S640). If the device driver for the detected hardware has already been installed, only the corresponding installation file is retrieved.

When the installation file exists, the corresponding application program is installed in the plug and install system 400 by using the installation file (S650 and S660).

After the application program is installed in the plug and install system 400, the corresponding installation program is deleted (S670).

According to aspects of the present invention, it is possible to remove the need for a user to manually install an application program associated with specific hardware.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plug and install system comprising:
a hardware-to-application mapping table to map predetermined hardware with a plurality of application programs associated with the predetermined hardware;
a storage module to store installation files of one or more application programs of the plurality of application programs that install the one or more application programs;
a hardware detecting module to detect newly installed hardware; and
a control module to select an application program, from the plurality of application programs, associated with the detected hardware from the hardware-to-application mapping table, to extract and/or receive an installation file that installs the selected application program, and to install the application program.

2. The plug and install system as claimed in claim 1, wherein the storage module stores a device driver to drive the detected hardware, and the control module extracts the device driver for the detected hardware from the storage module and executes the device driver.

3. The plug and install system as claimed in claim 1, wherein the storage module stores the hardware-to-application mapping table.

4. The plug and install system as claimed in claim 1, wherein the control module deletes the installation file after installing the selected application program.

5. The plug and install system as claimed in claim 1, further comprising:
an output module to display to a user a procedure of installing the selected application program by using the installation file, and to provide a user interface allowing the user to select the application program and/or choose whether to install the application program; and
an input module to transmit information on the application program selected by the user through the user interface to the control module.

6. The plug and install system as claimed in claim 1, further comprising a network interface module to receive the installation file that installs the selected application program from a remote network apparatus, of one or more remote network apparatuses, storing the installation file,
wherein the hardware-to-application mapping table maps the detected hardware with the selected application program associated with the detected hardware and information on the remote network apparatus storing the installation file; and the control module receives the installation file from the network interface module based on the information on the remote network apparatus mapped in the hardware-to-application mapping table, and installs the application program.

7. The plug and install system as claimed in claim 6, wherein the network interface module receives the installation file from the remote network apparatus if the control unit determines that the installation file is not stored in the storage module.

8. The plug and install system as claimed in claim 6, wherein the remote network apparatus or another remote network apparatus, of the one or more remote network apparatuses, stores the hardware-to-application mapping table.

9. The plug and install system as claimed in claim 6, wherein the remote network apparatus or another remote network apparatus, of the one or more remote network apparatuses, stores a device driver to drive the detected hardware, and the control module receives the device driver for the detected hardware from the network interface module connected to the remote network apparatus or the other remote network apparatus and executes the device driver.

10. A plug and install system comprising:
a hardware-to-application mapping table to map predetermined hardware with a plurality of application programs associated with the predetermined hardware and information on one or more remote network apparatuses storing installation files of one or more application programs of the plurality of application programs that install the one or more application programs;
a network interface module connected to the one or more remote network apparatuses to receive the installation files;
a hardware detecting module to detect newly installed hardware; and
a control module to select an application program, from the plurality of application programs, associated with the detected hardware from the hardware-to-application mapping table, to extract and/or receive an installation file that installs the selected application program, and to install the application program.

11. The plug and install system as claimed in claim 10, further comprising a storage module to store a device driver that drives the detected hardware, wherein the control module extracts the device driver for the detected hardware from the storage module and executes the device driver.

12. The plug and install system as claimed in claim 10, further comprising a storage module to store the installation file that installs the selected application program.

13. The plug and install system as claimed in claim 12, wherein the control module deletes the installation file after installing the selected application program.

14. The plug and install system as claimed in claim 12, wherein the network interface module receives the installation file from a remote network apparatus, of the one or more remote network apparatuses, if the control unit determines that the installation file is not stored in the storage module.

15. The plug and install system as claimed in claim 10, further comprising a storage module to store the hardware-to-application mapping table.

16. The plug and install system as claimed in claim 10, wherein a remote network apparatus, of the one or more remote network apparatuses, stores the hardware-to-application mapping table.

17. The plug and install system as claimed in claim 10, wherein the control module deletes the installation file after installing the selected application program.

18. The plug and install system as claimed in claim 10, further comprising:
an output module to display a procedure of installing the selected application program by using the installation file, and to provide a user interface allowing a user to select the application program and/or choose whether to install the application program; and
an input module to transmit information on the application program selected by the user through the user interface to the control module.

19. A plug and install method comprising:
detecting newly installed hardware;
retrieving an installation file to install an application file associated with the detected hardware; and
executing the retrieved installation file to install the application program.

20. The plug and install method as claimed in claim 19, further comprising executing a device driver to drive the detected hardware.

21. The plug and install method as claimed in claim 19, further comprising deleting the installation file after installing the application program.

22. The plug and install method as claimed in claim 19, wherein the retrieving of the installation file comprises:
displaying a list of a plurality of application programs associated with the detected hardware; and
retrieving the installation file to install the application program, of the plurality of application programs, selected by a user from the displayed list.

23. The plug and install method as claimed in claim 19, wherein the retrieving of the installation file comprises receiving from a remote network apparatus the installation file.

24. The plug and install method as claimed in claim 19, wherein the retrieving of the installation file comprises receiving from an internal storage module the installation file.

25. The plug and install method as claimed in claim 19, wherein the retrieving of the installation file comprises:
searching an internal storage module for the installation file;
receiving the installation module from the internal storage module when the installation file is in the internal storage module; and
receiving the installation file from a remote network apparatus when the installation file is not in the internal storage module.

26. The plug and install method as claimed in claim 19, wherein the retrieving of the installation file comprises receiving from a remote network apparatus the installation file.

27. A plug and install system comprising:
a hardware detecting module to detect newly installed hardware; and
a control module to select an application program associated with the detected hardware, to extract and/or receive an installation file that installs the selected application program, and to install the selected application program.

28. The plug and install system as claimed in claim 27, further comprising a hardware-to-application mapping table to map predetermined hardware with a plurality of application programs associated with the predetermined hardware,
wherein the control module selects the application program associated with the detected hardware from the hardware-to-application mapping table.

29. The plug and install system as claimed in claim 27, further comprising a storage module to store the installation file.

30. The plug and install system as claimed in claim 27, further comprising a storage module to store a device driver to drive the detected hardware, wherein the control module extracts the device driver for the detected hardware from the storage module and executes the device driver.

31. The plug and install system as claimed in claim 27, further comprising:
an output module to display to a user a procedure of installing the selected application program by using the installation file, and to provide a user interface allowing the user to select the application program and/or choose whether to install the application program; and
an input module to transmit information on the application program selected by the user through the user interface to the control module.

32. The plug and install system as claimed in claim 27, further comprising a network interface module to receive the installation file that installs the selected application program from a remote network apparatus, of one or more remote network apparatuses, storing the installation file.

33. The plug and install system as claimed in claim 32, further comprising a hardware-to-application mapping table to map predetermined hardware with a plurality of application programs associated with the predetermined hardware and information on the remote network apparatus storing the installation file,
wherein the control module selects the application program associated with the detected hardware from the hardware-to-application mapping table, and receives the installation file from the network interface module based on the information on the remote network apparatus mapped in the hardware-to-application mapping table.

34. The plug and install system as claimed in claim 32, further comprising a storage module capable of storing the installation file, wherein the network interface module receives the installation file from the remote network apparatus if the control unit determines that the installation file is not stored in the storage module.

35. A computer readable recording medium encoded with the method of claim 19 implemented by a computer.
